(19) United States
(12) Patent Application Publication
(10) Pub. No.: US 2011/0052481 A1
(43) Pub. Date: Mar. 3, 2011

(54) METHOD OF TREATING METALLIFERROUS MATERIALS

(75) Inventors: Dmitri Terekhov, Newmarket (CA); Nanthakumar Victor-Emmanuel, Richmond Hill (CA); Serge Kovtun, Mississauga (CA); Kamran Khozan, Dubai (AE)

(73) Assignee: CVMR CORPORATION, Toronto, Ontario (CA)

(21) Appl. No.: 12/990,283

(22) PCT Filed: Apr. 29, 2009
(86) PCT No.: PCT/CA09/00595

§ 371 Date: Oct. 29, 2010

Related U.S. Application Data
(62) Division of application No. 61/048,859, filed on Apr. 29, 2008.

(51) Int. Cl. C01B 9/00

(52) U.S. Cl. 423/491

(57) ABSTRACT

There is provided a process of treating a metalliferrous material including at least one metal material fraction. Each one of the at least one metal material fraction includes a respective metal, wherein the respective metal is a transition metal. Each one of the at least one metal material fraction also includes a respective first operative material fraction and a respective second operative material fraction. The respective first operative material fraction consists of an elemental form of the respective metal, and the respective second operative material fraction consists of at least one oxide of the respective metal. The method includes providing reagent material including at least one diatomic halogen and at least one aluminium halide. The reagent material is contacted with the metalliferrous material in a reaction zone so as to effect a reactive process which effects production of an intermediate reaction product including at least one produced metal halide. Each one of the at least one produced metal halide includes a respective metal corresponding to the respective metal of a respective one of the at least one metal material fraction. A separation fraction is separated from the intermediate reaction product. The separation fraction includes at least one recovered metal halide.

### RELATED APPLICATION

This application claims priority to U.S. Provisional Patent Application Ser. No. 61/048,859 filed on Apr. 29, 2008.

### FIELD OF THE INVENTION

The present invention relates to the purification of metalliferrous materials.

### BACKGROUND OF THE INVENTION

Chemical vapour deposition of metals using metal iodide is a well known process. This process was developed by Van Arkel, de Boer and Fast (Reference No. 1). The method is used for transition metals such as Ti, Zr, Hf, Nb, Ta, Fe, and Cr. (Reference No. 2). Usually, purification and deposition of metals using the so-called de Boer deposition bulb is effected under vacuum. Using this apparatus, impure metal reacts with iodine gas to produce volatile metal iodide (Reference No. 3). Metal iodide is transported as a gas to a heated filament (typically above 1000° C.), where it is decomposed to pure metal and iodine gas. Released iodine reacts again with impure metal. The deposition rate is usually 0.01-0.10 mm/hour. The same method can also be used for production of metal alloys, when more than one metal iodide is decomposed on a filament (Reference No. 2).

Alternatively, metal iodides can be used as a precursor for direct deposition. For example, heated filaments have been immersed in liquid TiI₄ to produce Ti metal (Reference No. 4) and ZrI₄ has been decomposed into Zr metal and iodine in a plasma furnace (Reference No. 5). This facilitates the increasing deposition rates by a factor of 10× to 100×. Metal iodides have also been formed by direct reaction of metals with iodine (Reference No. 2) or reaction of AlI₃ with metal oxides (Reference No. 6).

### SUMMARY OF THE INVENTION

In one aspect, there is provided a process of treating a metalliferrous material including at least one target metal material fraction, wherein each one of the at least one target metal material fraction includes a respective target metal, wherein the respective target metal is a transition metal, and wherein each one of the at least one target metal material fraction includes a respective first operative material fraction and a respective second operative material fraction, and wherein the respective first operative material fraction consists of an elemental form of the respective target metal, and wherein the respective second operative material fraction consists of at least one oxide of the respective target metal, comprising:

providing reagent material including at least one diatomic halogen and at least one aluminium halide;
contacting the reagent material with the metalliferrous material in a reaction zone so as to effect a reactive process which effects production of an intermediate reaction product including at least one produced metal halide, and wherein each one of the at least one produced metal halide includes a respective metal corresponding to the respective target metal of a respective one of the at least one target metal material fraction; and
separating a separation fraction from the intermediate reaction product, wherein the separation fraction includes at least one recovered metal halide, wherein each one of the at least one recovered metal halide is a one of the at least one produced metal halide.
In another aspect, there is provided A process of treating a metalliferrous material including at least one target metal material fraction, wherein each one of the at least one target metal material fraction includes a respective target metal, and wherein the respective target metal of each one of the at least one target metal material fraction is a transition metal, and wherein each one of the at least one target metal material fraction includes a respective first operative material fraction and a respective second operative material fraction, and wherein the respective first operative material fraction consists of an elemental form of the respective target metal and the respective second operative material fraction consists of at least one oxide of the respective target metal, comprising:
providing reaction material in a reaction zone, wherein the reaction material includes the metalliferrous material and aluminium-comprising material, wherein the aluminium-comprising material includes aluminium;
contacting the reaction material with at least one diatomic halogen to effect a reactive process which effects production of an intermediate reaction product including at least one produced metal halide, and wherein each one of the at least one produced metal halide includes a respective metal corresponding to the respective target metal of a respective one of the at least one target metal material fraction; and
separating a separation fraction from the intermediate reaction product, wherein the separation fraction includes at least one recovered metal halide, wherein each one of the at least one recovered metal halide is a one of the at least one produced metal halide.
In another aspect, there is provided A process of treating a metalliferrous material including at least one target metal material fraction and at least one non-target metal material fraction, wherein each one of the at least one target metal material fraction includes a respective target metal, and the respective target metal is a transition metal, and wherein each one of the at least one target metal material fraction includes a respective metal oxide material fraction, and the respective metal oxide material fraction consists of at least one oxide of the respective target metal, and wherein each one of the at least one non-target metal material fraction includes a respective non-target metal, and wherein the halide of the respective target metal of each one of the at least one target metal material fraction is relatively more volatile than the halide of the respective non-target metal of each one of the at least one non-target metal material fraction, comprising:
providing reagent material including at least one halide of aluminium;
contacting the reagent material with the metalliferrous material in a reaction zone so as to effect a reactive process which effects production of an intermediate reaction product including at least one produced target metal halide, and wherein each one of the at least one produced target metal halide includes a respective target metal corresponding to the respective target metal of a respective one of the at least one target metal material fraction; and
separating a separation fraction from the intermediate reaction product, wherein the separation fraction includes at least one recovered target metal halide, wherein each one of the at least one recovered target metal halide is a one of the at least one produced target metal halide.
In a further aspect, there is provided a process of treating a metalliferrous material including at least one target metal material fraction and at least one non-target metal material fraction, wherein each one of the at least one target metal material fraction includes a respective target metal, and the respective target metal is a transition metal, and wherein each one of the at least one target metal material fraction includes a respective metal oxide material fraction, and the respective metal oxide material fraction consists of at least one oxide of the respective target metal, and wherein each one of the at least one non-target metal material fraction includes a respective non-target metal, and wherein the halide of the respective target metal of each one of the at least one target metal material fraction is relatively more volatile than the halide of the respective non-target metal of each one of the at least one non-target metal material fraction, comprising:
providing reaction material in a reaction zone, wherein the reaction material includes the metalliferrous material and aluminium-comprising material, wherein the aluminium-comprising material includes aluminium;
contacting the reaction material with at least one diatomic halogen to effect a reactive process to produce an intermediate reaction product including at least one produced target metal halide, wherein each one of the at least one produced target metal halide material includes a respective target metal corresponding to the respective target metal of a respective one of the at least one target metal material fraction; and
separating a separation fraction from the intermediate reaction product, wherein the separation fraction includes at least one recovered target metal halide, wherein each one of the at least one recovered target metal halide is a one of the at least one produced target metal halide.

### BRIEF DESCRIPTION OF DRAWINGS

The invention will be better understood when consideration is given to the following detailed description thereof. Such description makes reference the annexed drawings wherein:

FIG. 1 is a schematic illustration of the testing apparatus referred to in the Examples; and

FIG. 2 is a flowsheet illustrating an embodiment of a system of the present invention.

### DETAILED DESCRIPTION OF PREFERRED EMBODIMENTS

There is provided a process of treating a metalliferrous material.

For example, with respect to the metalliferrous material, the metalliferrous material is in the form of a solid, such as a particulate material or a powder. For example, with respect to the particulate material, 95 weight % of the particulate material is characterized by a particle size within the range of between about 10 mesh and about 100 mesh. As a further example, the metalliferrous material is in the form of a swarf or any other form characterized by a relatively high surface area.

In some embodiments, the metalliferrous material includes at least one target metal material fraction. Each one of the at least one target metal material fraction includes a respective target metal. The respective target metal of each one of the at least one target metal material fraction is a transition metal. For example, with respect to the transition metal, the transition metal is any one element selected from the group consisting of Sc, Ti, V, Cr, Mn, Fe, Co, Ni, Cu, Zn, Y, Zr, Nb, Tc, Ru, Rh, Pd, Ag, Cd, La, Hf, Ta, W, Os, Au, and Ac. Each one of the at least one target metal material fraction includes a respective first operative fraction and a respective second operative fraction. The respective first operative fraction consists of an elemental form of the respective target metal. The respective second operative fraction consists of at least one oxide of the respective target metal

In some embodiments, the metalliferrous material includes at least one target metal material fraction and at least one non-target metal material fraction. Each one of the at least one target metal material fraction includes a respective target metal such that the metalliferrous material includes at least one target metal. The respective target metal of each one of the at least one target metal material fraction is a transition metal. For example, with respect to the transition metal, the transition metal is any one element selected from the group consisting of Sc, Ti, V, Cr, Mn, Fe, Co, Ni, Cu, Zn, Y, Zr, Nb, Tc, Ru, Rh, Pd, Ag, Cd, La, Hf, Ta, W, Os, Au, and Ac. Each one of the at least one target metal material fraction includes a respective metal oxide material fraction, and the respective metal oxide material fraction consists of at least one oxide of the respective target metal. Each one of the at least one non-target metal material fraction includes a respective non-target metal and the respective non-target metal is a metal which is other than each one of the at least one target metal of the metalliferrous material. For example, the respective non-target metal of each one of the at least one non-target metal material fraction is other than a transition metal. The halide of the respective target metal of each one of the at least one target metal material fraction is relatively more volatile than the halide of the respective non-target metal of each one of the at least one non-target metal material fraction

The term “metalliferrous material” refers to any material which includes a metal. For example, the metalliferrous material is an ore or a concentrate. As a further example, the metalliferrous material is recycled material.

The term “metal material” describes, with respect to the respective metal, the elemental form of the respective metal, an alloy of the respective metal, or a compound of the respective metal, or an homogeneous or inhomogeneous combination of any one of the elemental form of the respective metal, an alloy of the respective metal, or a compound of the respective metal.

### A FIRST EMBODIMENT

In one embodiment, there is provided a process for treating a metalliferrous material including at least one metal material fraction. The process includes providing reagent material including at least one diatomic halogen and at least one aluminium halide. The reagent material is contacted with the metalliferrous material in a reaction zone so as to effect a reactive process which effects production of an intermediate reaction product including at least one produced metal halide. Each one of the at least one produced metal halide includes a respective metal corresponding to the respective target metal of a respective one of the at least one target metal material fraction. A separation fraction is separated from the intermediate reaction product. The separation fraction includes at least one recovered metal halide. Each one of the at least one recovered metal halide is a one of the at least one produced metal halide. The halogen of at least one of the at least one recovered metal halide corresponds to the halogen of at least one of the at least one aluminium halide.

In some embodiments, the halogen of each one of the at least one diatomic halogen is selected from the group consisting of iodine, bromine, and chlorine. For example, the at least one diatomic halogen is diatomic iodine.

In some embodiments, the halogen of each one of the at least one recovered metal halide corresponds to at least one of: (i) the halogen of at least one of the at least one aluminium halide, and (ii) the halogen of a one of the at least one diatomic halogen.

In some embodiments, the halogen of the aluminium halide is selected from the group consisting of iodine, bromine, and chloride. For example, the aluminium halide is aluminium iodide.

For example, with respect to the separating of the separation fraction from the intermediate reaction product, the separating of the separation fraction from the intermediate reaction product includes subjecting at least a fraction of the intermediate reaction product to a distillation process to effect production of the separation fraction. In this embodiment, the distillation process improves the purity of the at least one target metal in the separation fraction. In this respect, at least an intermediate operative fraction is provided, wherein the at least an intermediate operative fraction is the at least a fraction of the intermediate reaction product which is subjected to the distillation process, and the at least an intermediate operative fraction includes an intermediate operative target metal fraction, wherein the intermediate operative target metal fraction consists of a respective metal of each one of the at least one produced metal halide. The distillation process effects distilling of an operative separation fraction from the intermediate operative fraction, wherein the separation fraction includes the operative separation fraction, and wherein the operative separation fraction is purified in the intermediate operative target metal fraction relative to the intermediate operative fraction.

For example, with respect to the separating of the separation fraction from the intermediate reaction product, the separating a separation fraction from the intermediate reaction product includes separating at least an intermediate operative fraction from the intermediate reaction product and distilling an operative separation fraction from the intermediate operative fraction. With respect to the separating of at least an intermediate operative fraction from intermediate reaction product, the intermediate operative fraction includes an intermediate operative fraction target metal material fraction including a respective total concentration of target metal. The intermediate operative fraction target metal material fraction consists of at least one intermediate operative fraction produced metal halide. Each one of the at least one intermediate operative fraction produced metal halide is a one of the at least one produced metal halide, such that the intermediate operative fraction target metal material fraction includes at least one target metal. Each one of the at least one target metal is provided in a respective concentration within the intermediate operative fraction target metal material fraction such that at least one target metal concentration is provided within the intermediate operative fraction target metal material fraction. In this respect, the respective total concentration of target metal of the intermediate operative fraction target metal material fraction is the sum of the at least one target metal concentration provided within the intermediate operative fraction target metal material fraction. With respect to the distilling of an operative separation fraction from the intermediate operative fraction, the separation fraction includes the operative separation fraction. The operative separation fraction includes an operative separation fraction target metal material fraction including a respective total concentration of target metal. The operative separation fraction target metal material fraction consists of at least one operative separation fraction recovered metal halide. Each one of the at least one operative separation fraction recovered metal halide is a one of the at least one recovered metal halide, such that the operative separation fraction target metal material fraction includes at least one target metal. Each one of the at least one target metal is provided in a respective concentration within the operative separation fraction target metal material fraction, such that at least one target metal concentration is provided within the operative separation fraction target metal material fraction. In this respect, the respective total concentration of target metal of the operative separation fraction target metal material fraction is the sum of the at least one target metal concentration provided within the operative separation fraction target metal material fraction. The respective total concentration of target metal in the operative separation fraction target metal material fraction of the operative separation fraction is greater than the respective total concentration of target metal in the intermediate operative fraction target metal material fraction intermediate operative fraction. For example, the distilling is effected under atmospheric pressure in a distillation zone characterized by a temperature of between 230 degrees Celsius and 400 degrees Celsius.

For example, with respect to the separation of the separation fraction from the intermediate reaction product, the separation of the separation fraction from the intermediate reaction product provides a residual of the intermediate reaction product. The residual includes iodine, and the iodine is separated from the residual and recycled to the reaction zone. For example, the iodine is in the form of a metal iodide in the residual. At least a fraction of the metal iodide (such as iron iodide) is separated from the residual by washing the residual with water or an organic solvent (such as an alcohol, or an aqueous alcohol solution) to effect solubilization of at least a portion of solids (including iron iodide) of the residual and produce a mixture including a liquid phase and a solid remainder including aluminium oxide. The solid remainder is separated from the mixture by a conventional solid-liquid separation process, such as mechanical filtration. The iron iodide in the liquid phase is subjected to a reactive process to effect production of gaseous iodine. For example, the reactive process is effected by contacting the liquid phase with chlorine.

For example, with further respect to the separation of the separation fraction, the separation of the separation fraction from the intermediate reaction product provides a residual of the intermediate reaction product, wherein the residual includes aluminium oxide, and wherein at least a fraction of the aluminium oxide of the residual is separated from the residual and subjected to a reactive process (such as electrolysis) to effect production of elemental aluminium, and the elemental aluminium is recycled to the reaction zone (where it is configured to be contacted by iodine to effect a reactive process which effects production of aluminium iodide). For example, with respect to the separation of the at least a fraction of the aluminium oxide from the residual, the at least a fraction of the aluminium oxide is separated from the residual by washing the residual with water or an organic solvent (such as an alcohol) to effect solubilization of at least a portion of the residual to produce a mixture including a liquid phase and a solid remainder including aluminium oxide. The solid remainder is separated from the mixture by a conventional solid-liquid separation process, such as mechanical filtration. Aluminium is then recovered from the aluminium oxide of the solid remainder, such as by way of electrolysis.

For example, with respect to the contacting of the reagent material with the metalliferrous material in a reaction zone to effect a reactive process which effects production of an intermediate reaction product including at least one produced metal halide, the contacting of the reagent material with the metalliferrous material in a reaction zone to effect a reactive process which effects production of an intermediate reaction product including at least one produced metal halide includes contacting of the at least one aluminium halide of the reagent material with the respective second operative material fraction of at least one operative target metal material fraction, wherein each one of the at least one operative target metal material fraction is a one of the at least one target metal material fraction, and wherein, for each one of the at least one operative target metal material fraction, the contacting of the at least one aluminium halide with the respective second operative material fraction of the respective one of the at least one operative target metal material fraction effects a reactive process which effects production of a respective produced metal halide, wherein the respective produced metal halide is a halide of the respective metal of the respective one of the at least one operative target metal material fraction, and wherein the respective produced metal halide is a one of the at least one produced metal halide, and wherein the halogen of the respective produced metal halide corresponds to the halogen of at least one of the at least one aluminium halide with which the contacting is being effected. When the reagent material includes at least one diatomic halogen, the contacting of the reagent material with the metalliferrous material in a reaction zone to effect a reactive process which effects production of an intermediate reaction product including at least one produced metal halide further includes contacting of at least one operative diatomic halogen of the reagent material with the respective first operative material fraction of at least one operative target metal material fraction, wherein each one of the at least one operative target metal material fraction is a one of the at least one target metal material fraction, and wherein each one of the at least one operative diatomic halogen is a one of the at least one diatomic halogen, and wherein, for each one of the at least one operative metal material fraction, the contacting of the at least one operative diatomic halogen with the respective first operative material fraction of the respective one of the at least one operative target metal material fraction effects a reactive process which effects production of a respective produced metal halide wherein the respective produced metal halide is a halide of the respective metal of the respective one of the at least one operative metal material fraction, and wherein the respective produced metal halide is a one of the at least one produced metal halide, and wherein the halogen of the respective produced metal halide corresponds to the halogen of at least one of the at least one operative diatomic halogen with which the contacting is being effected.

For example, when the contacting is between a diatomic halogen of the reagent material and a first operative material fraction of a metal material fraction, wherein the diatomic halogen is diatomic iodine, and wherein the respective target metal of the target metal material fraction is titanium, production of titanium iodide is effected in accordance with the following reaction:

Ti+2I₂→TiI₄

For example, when the contacting is between aluminium iodide of the reagent material and second operative material fraction of a metal material fraction, wherein the respective metal of the metal material fraction is titanium, and wherein the second operative fraction is titanium dioxide, production of titanium dioxide is effected in accordance with the following reaction:

3TiO₂+4AlI₃→3TiI₄+2Al₂O₃

For example, the reactive process, which effects production of an intermediate reaction product including at least one produced metal halide (such as titanium iodide), is effected in a reaction zone at a pressure of between about 1 bar and about 10 bar (for example, between about 1 bar and about 5 bar) and at a temperature of between about 100 degrees Celsius and about 500 degrees Celsius (for example, between about 230 degrees Celsius and about 450 degrees Celsius).

For example, with respect to the aluminium iodide of the reagent material, the aluminium iodide is produced by contacting an aluminium-comprising material with gaseous diatomic iodine to effect a reactive process. For example, the gaseous iodine is derived from solid state iodine.

For example, with respect to the diatomic halogen of the reagent material, when the diatomic halogen is diatomic iodine, the iodine of the diatomic iodine is derived from solid state iodine. For example, with respect to the solid state iodine used in the embodiments of the process, the solid state iodine is in the form of a particulate material or a powder.

For example, with respect to each one of the at least one metal material fraction, the molar ratio of (i) the first operative fraction, to (ii) the second operative fraction, is from about 99:1 to about 1:99. For example, this molar ratio is between about 9:1 and about 1:9.

For example, with respect to the at least one aluminium halide of the reagent material, at least a fraction of the at least one aluminium halide may remain unreacted and thereby define unreacted aluminium halide. In some embodiments of such cases, the method further includes providing at least one aluminium halide-reactive material. At least a fraction of any unreacted aluminium halide is then contacted with the at least one aluminium halide-reactive material to effect production of a relatively non-volatile aluminum material, and wherein, relative to each one of the at least one aluminum halide, the relatively non-volatile aluminum material is less volatile than at least one of the at least one aluminum halide. Each one of the at least one aluminium halide-reactive material is a halide of an element selected from either one of group I or group II of the periodic table of the elements. For example, the aluminium halide is aluminium iodide, and the provided aluminium halide-reactive material is potassium iodide, and any unreacted aluminium iodide is contacted with the potassium iodide to effect production of a relatively non-volatile aluminium material, namely, potassium aluminum iodide (KAlL₄). Relative to the aluminium iodide, potassium is less volatile than the aluminium iodide. For example, the relatively non-volative aluminium material does not substantially evaporate at pressures of between about 0.1 bar and about 1 bar and temperatures of between about 100 degrees Celsius and about 400 degrees Celsius. In this respect, in some embodiments, the at least one aluminium halide-reactive material is provided and contacted with at least a fraction of any unreacted aluminium halide prior to the distilling of the operative separation fraction from the intermediate operative fraction. For example, the at least one aluminium halide-reactive material is provided in the reaction material such that the reaction material includes the at least one aluminium halide-reactive material.

For example, with respect to the separation fraction, the separation fraction is disposed in a different material state than that of the metalliferrous material. As a further example, the separation fraction is disposed in at least one of a gaseous state or a liquid state, and the metalliferrous material is disposed in a solid state. For example, with respect to the separation fraction, the separation fraction is subjected to a reactive process by heating the separation fraction to a temperature of between about 900 degrees Celsius and about 1800 degrees Celsius. For example, the reactive process is effected by contacting the separation fraction with a heated surface disposed at a temperature of between about 900 degrees Celsius and about 1800 degrees Celsius. For example, the heated surface is in the form of a tube, a rod, a filament, or a wire. For example, the reactive process to which the separation fraction is subjected is effected under sub-atmospheric pressure. For example, the reactive process to which the separation fraction is subjected effects production of any one of a metallic alloy, a metallic net shape, a metallic powder or a metallic coating, wherein the any one of the metallic alloy, the metallic net shape, the metallic powder or the metallic coating includes the respective metal of at least one of the at least one recovered metal halide.

For example, with respect to the subjecting of the separation fraction to the reactive process, the subjecting of the separation fraction to the reactive process effects production of the elemental form of the respective metal of at least one of the at least one recovered metal halide of the separation fraction. As a further example, where the separation fraction includes two metal halides, subjecting the separation fraction to the reactive process effects production of an alloy including the respective metal of each one of the two metal halides of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a coating on a substrate, wherein the coating includes the respective metal of at least one of the at least one recovered metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a metal net shape, wherein the metal net shape includes the respective metal of at least one of the at least one recovered metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, where the temperature of the heated surface is greater than the melting point of the respective metal of at least one of the at least one recovered metal halide of the separation fraction, produces metal drops which are solidified into powder form.

For example, with respect to the at least one recovered metal halide of the separation fraction, at least one of the at least one metal halide of the separation fraction is disposed in a different material state than that of the metalliferrous material. As a further example, at least one of the at least one metal halide of the separation fraction is disposed in at least one of a gaseous state or a liquid state, and the metalliferrous material is disposed in a solid state.

For example, with further respect to the at least one recovered metal halide of the separation fraction, at least one operative recovered metal halide of the separation fraction is subjected to a reactive process which effects production of the elemental form of the respective metal of at least one of the at least one operative recovered metal halide of the separation fraction. Each one of the at least one operative recovered metal halide is a one of the at least one recovered metal halide.

For example, with respect to the reactive process which effects production of the elemental form of the respective metal of at least one of the at least one metal halide material of the separation fraction, the reactive process includes a decomposition reaction. For example, the decomposition reaction is effected in a plasma, such as an argon plasma characterized by a temperature of about 3000 degrees Celsius. For example, the produced elemental form of the respective metal is disposed in a liquid state.

For example, with further respect to the reactive process which effects production of the elemental form of the respective metal of at least one of the at least one operative recovered metal halide of the separation fraction, the reactive process is effected by heating the at least one operative recovered metal halide of the separation fraction to a temperature of between about 900 degrees Celsius and about 1800 degrees Celsius.

For example, with further respect to the reactive process which effects production of the elemental form of the respective metal of at least one of the at least one operative recovered metal halide of the separation fraction, the reactive process is effected by contacting the at least one operative recovered metal halide of the separation fraction with a heated surface disposed at a temperature of between about 900 degrees Celsius and about 1800 degrees Celsius. For example, the heated surface is in the form of a tube, a rod, a filament, a wire, or plasma.

For example, with further respect to the reactive process which effects production of the elemental form of the respective metal of at least one of the at least one operative recovered metal halide of the separation fraction, the reactive process also effects production of at least one produced diatomic halogen, and at least a fraction of the at least one produced diatomic halogen is recycled to the reaction zone. For example, with respect to the at least one produced diatomic halogen, the at least one produced diatomic halogen is gaseous iodine. For example, at least a fraction of the gaseous iodine is separated from the product, and the at least a fraction of the gaseous iodine is condensed as solid iodine, and the solid iodine is recycled to the reaction zone to effect the contacting with the metalliferrous material to effect production of the at least one intermediate reaction product. For example, the condensing of the gaseous iodine is effected in a cold trap.

### A SECOND EMBODIMENT

In another embodiment, there is provided a process for treating metalliferrous material including at least one target metal material fraction. Each one of the at least one target metal material fraction includes a respective target metal. The respective target metal of each one of the at least one target metal material fraction is a transition metal. Each one of the at least one target metal material fraction includes a respective first operative material fraction and a respective second operative material fraction. The respective first operative material fraction consists of an elemental form of the respective target metal and the respective second operative material fraction consists of at least one oxide of the respective target metal. The method includes providing reaction material in a reaction zone, wherein the reaction material includes the metalliferrous material and aluminium-comprising material, wherein the aluminium-comprising material includes aluminium. The reaction material is contacted with at least one diatomic halogen to effect a reactive process which effects production of an intermediate reaction product including at least one produced metal halide. Each one of the at least one produced metal halide includes a respective metal corresponding to the respective target metal of a respective one of the at least one target metal material fraction. A separation fraction is separated from the intermediate reaction product. The separation fraction includes at least one recovered metal halide, wherein each one of the at least one recovered metal halide is a one of the at least one produced metal halide. For example, the halogen of at least one of the recovered metal halide corresponds to the halogen of at least one of the at least one diatomic halogen.

In some embodiments, the halogen of each one of the at least one diatomic halogen is selected from the group consisting of iodine, bromine, and chlorine. For example, the at least one diatomic halogen is diatomic iodine.

In some embodiments, the halogen of each one of the at least one recovered metal halide corresponds to at least one of: (i) the halogen of at least one of the at least one aluminium halide, and (ii) the halogen of a one of the at least one diatomic halogen.

In some embodiments, the halogen of the aluminium halide is selected from the group consisting of iodine, bromine, and chloride. For example, the aluminium halide is aluminium iodide.

For example, with respect to the aluminium comprising material being contacted by the diatomic halogen, the aluminium comprising material is in the form of particulate matter, off-cuts, or shavings. For example, any one of the particulate matter, the off-cuts, or the shavings is characterized by a diameter of less than one inch.

For example, with respect to the aluminium comprising material being contacted by the diatomic halogen, the aluminium-comprising material consists essentially of aluminium.

For example, the diatomic halogen is diatomic iodine. With respect to the diatomic iodine contacting the aluminium containing material, the diatomic iodine is derived from solid state iodine. For example, the solid state iodine is provided in the reaction zone. For example, with respect to the solid state iodine, the solid state iodine is in the form of a powder.

For example, with respect to the reaction material, the reaction material includes from about 30 weight % to about 95 weight % of the metalliferrous material, based on the total weight of the reaction material, and the weight of the provided at least one diatomic halogen is from about 1% to about 5% above stoichiometric proportion, and the weight of the provided aluminium is from about 2% to about 5% above stoichiometric proportion.

For example, with respect to the separating of the separation fraction from the intermediate reaction product, the separating of the separation fraction from the intermediate reaction product includes subjecting at least a fraction of the intermediate reaction product to a distillation process to effect production of the separation fraction. In this embodiment, the distillation process improves the purity of the at least one target metal in the separation fraction. In this respect, at least an intermediate operative fraction is provided, wherein the at least an intermediate operative fraction is the at least a fraction of the intermediate reaction product which is subjected to the distillation process, and the at least an intermediate operative fraction includes an intermediate operative target metal fraction, wherein the intermediate operative target metal fraction consists of a respective metal of each one of the at least one produced metal halide. The distillation process effects distilling of an operative separation fraction from the intermediate operative fraction, wherein the separation fraction includes the operative separation fraction, and wherein the operative separation fraction is purified in the intermediate operative target metal fraction relative to the intermediate operative fraction.

For example, with respect to the separating of the separation fraction from the intermediate reaction product, the separating a separation fraction from the intermediate reaction product includes separating at least an intermediate operative fraction from the intermediate reaction product and distilling an operative separation fraction from the intermediate operative fraction. With respect to the separating of at least an intermediate operative fraction from intermediate reaction product, the intermediate operative fraction includes an intermediate operative fraction target metal material fraction including a respective total concentration of target metal. The intermediate operative fraction target metal material fraction consists of at least one intermediate operative fraction produced metal halide. Each one of the at least one intermediate operative fraction produced metal halide is a one of the at least one produced metal halide, such that the intermediate operative fraction target metal material fraction includes at least one target metal. Each one of the at least one target metal is provided in a respective concentration within the intermediate operative fraction target metal material fraction such that at least one target metal concentration is provided within the intermediate operative fraction target metal material fraction. In this respect, the respective total concentration of target metal of the intermediate operative fraction target metal material fraction is the sum of the at least one target metal concentration provided within the intermediate operative fraction target metal material fraction. With respect to the distilling of an operative separation fraction from the intermediate operative fraction, the separation fraction includes the operative separation fraction. The operative separation fraction includes an operative separation fraction target metal material fraction including a respective total concentration of target metal. The operative separation fraction target metal material fraction consists of at least one operative separation fraction recovered metal halide. Each one of the at least one operative separation fraction recovered metal halide is a one of the at least one recovered metal halide, such that the operative separation fraction target metal material fraction includes at least one target metal. Each one of the at least one target metal is provided in a respective concentration within the operative separation fraction target metal material fraction, such that at least one target metal concentration is provided within the operative separation fraction target metal material fraction. In this respect, the respective total concentration of target metal of the operative separation fraction target metal material fraction is the sum of the at least one target metal concentration provided within the operative separation fraction target metal material fraction. The respective total concentration of target metal in the operative separation fraction target metal material fraction of the operative separation fraction is greater than the respective total concentration of target metal in the intermediate operative fraction target metal material fraction intermediate operative fraction. For example, the distilling is effected under atmospheric pressure in a distillation zone characterized by a temperature of between 230 degrees Celsius and 400 degrees Celsius.

For example, with respect to the separation of the separation fraction from the intermediate reaction product, the separation of the separation fraction from the intermediate reaction product provides a residual of the intermediate reaction product. The residual includes iodine, and the iodine is separated from the residual and recycled to the reaction zone. For example, the iodine is in the form of a metal iodide in the residual. At least a fraction of the metal iodide (such as iron iodide) is separated from the residual by washing the residual with water or an organic solvent (such as an alcohol, or an aqueous alcohol solution) to effect solubilization of at least a portion of solids (including iron iodide) of the residual and produce a mixture including a liquid phase and a solid remainder including aluminium oxide. The solid remainder is separated from the mixture by a conventional solid-liquid separation process, such as mechanical filtration. The iron iodide in the liquid phase is subjected to a reactive process to effect production of gaseous iodine. For example, the reactive process is effected by contacting the liquid phase with chlorine.

For example, with further respect to the separation of the separation fraction, the separation of the separation fraction from the intermediate reaction product provides a residual of the intermediate reaction product, wherein the residual includes aluminium oxide, and wherein at least a fraction of the aluminium oxide of the residual is separated from the residual and subjected to a reactive process (such as electrolysis) to effect production of elemental aluminium, and the elemental aluminium is recycled to the reaction zone (where it is configured to be contacted by iodine to effect a reactive process which effects production of aluminium iodide). For example, with respect to the separation of the at least a fraction of the aluminium oxide from the residual, the at least a fraction of the aluminium oxide is separated from the residual by washing with water or an organic solvent (such as an alcohol) to effect solubilization of at least a portion of the residual solid to produce a mixture including a liquid phase and a solid remainder including aluminium oxide. The solid remainder is separated from the mixture by a conventional solid-liquid separation process, such as mechanical filtration. Aluminium is then recovered from the aluminium oxide of the solid remainder, such as by way of electrolysis.

For example, with respect to the contacting of the at least one diatomic halogen with the reaction material in a reaction zone to effect a reactive process which effects production of an intermediate reaction product including at least one produced metal halide, the contacting includes contacting of at least one operative diatomic halogen with the aluminium-comprising material to effect a reactive process which effects production of at least one aluminium halide, wherein each one of the at least one operative diatomic halogen as a one of the at least one diatomic halogen. The at least one produced aluminium halide of the reagent material is then contacted with the respective second operative material fraction of at least one operative target metal material fraction, wherein each one of the at least one operative metal material fraction is a one of the at least one target metal material fraction, and wherein, for each one of the at least one operative target metal material fraction, the contacting of the aluminium halide with the respective second operative material fraction of the respective one of the at least one operative target metal material fraction effects a reactive process which effects production of a respective produced metal halide, wherein the respective produced metal halide is a halide of the respective metal of the respective one of the at least one metal material fraction, and wherein the respective produced metal halide is a one of the at least one produced metal halide, and wherein the halogen of the respective metal halide corresponds to the halogen of at least one of the at least one aluminium halide with which the contacting is being effected.

For example, with further respect to the contacting of the at least one diatomic halogen with the reaction material in a reaction zone to effect a reactive process which effects production of an intermediate reaction product including at least one produced metal halide, the contacting also includes contacting at least one operative diatomic halogen with the respective first operative material fraction of at least one operative target metal material fraction, wherein each one of the at least one operative target metal material fraction is a one of the at least one target metal material fraction, and wherein each one of the at least one operative diatomic halogen is a one of the at least one diatomic halogen, and wherein, for each one of the at least one operative target metal material fraction, the contacting of the at least one operative diatomic halogen with the respective first operative material fraction of the respective one of the at least one operative target metal material fraction effects a reactive process which effects production of a respective metal halide wherein the respective metal halide is a halide of the respective target metal of the respective one of the at least one target metal material fraction, and wherein the respective produced metal halide is a one of the at least one produced metal halide, and wherein the halogen of the respective metal halide corresponds to the halogen of at least one of the at least one operative diatomic halogen with which the contacting is being effected.

For example, the reaction zone, in which the reactive process effects production of an intermediate reaction product including at least one produced metal halide, is disposed at a pressure of between about 1 bar and about 10 bar (for example, between about 1 bar and about 5 bar) and at a temperature of between about 100 degrees Celsius and about 500 degrees Celsius (for example, between about 230 degrees Celsius and about 450 degrees Celsius).

For example, with respect to each one of the at least one metal material fraction, the molar ratio of (i) the first operative fraction, to (ii) the second operative fraction, is from about 99:1 to about 1:99. For example, this molar ratio is between about 9:1 and about 1:9.

For example, with respect to the at least one produced aluminium halide, at least a fraction of the produced aluminium halide of the reagent material may remain unreacted. In this respect, the reaction material further includes at least one aluminium halide-reactive material. Each one of the at least one aluminium halide-reactive material is a material of an element selected from either one of group I or group II of the periodic table of the elements. For example, the aluminium halide is aluminium iodide, and the at least one aluminium halide-reactive material is potassium iodide. The at least a fraction of any unreacted aluminium halide is contacted with the at least one aluminium halide-reactive material to effect production of a relatively non-volatile aluminium material. For example, the aluminium halide is aluminium iodide, and the aluminium halide-reactive material is potassium iodide, and any unreacted aluminium iodide is contacted with the potassium iodide to effect productions of potassium aluminium iodide (which is the relatively non-volatile aluminium material which is less volatile than the aluminium iodide). For example, the relatively non-volative aluminium material does not substantially evaporate at pressures of between about 0.1 bar and about 1 bar and temperatures of between about 100 degrees Celsius and about 400 degrees Celsius. In this respect, in some embodiments, the at least one aluminium halide-reactive material is provided and contacted with at least a fraction of any unreacted aluminium halide prior to the distilling of the operative separation fraction from the intermediate operative fraction. For example, the at least one aluminium halide-reactive material is provided in the reaction material such that the reaction material includes the at least one aluminium halide-reactive material.

For example, with respect to the separation fraction, the separation fraction is disposed in a different material state than that of the metalliferrous material. As a further example, the separation fraction is disposed in at least one of a gaseous state or a liquid state, and the metalliferrous material is disposed in a solid state.

For example, with respect to the separation fraction, the separation fraction is subjected to a reactive process by heating the separation fraction to a temperature of between about 900 degrees Celsius and about 1800 degrees Celsius. For example, the reactive process is effected by contacting the separation fraction with a heated surface disposed at a temperature of between about 900 degrees Celsius and about 1800 degrees Celsius. For example, the heated surface is in the form of a tube, a rod, a filament, or a wire. For example, the reactive process to which the separation fraction is subjected is effected under sub-atmospheric pressure. For example, the reactive process to which the separation fraction is subjected effects production of any one of a metallic alloy, a metallic net shape, a metallic powder or a metallic coating, wherein each one of the metallic alloy, the metallic net shape, the metallic powder or the metallic coating includes the respective metal of at least one of the at least one recovered metal halide.

For example, with respect to the subjecting of the separation fraction to the reactive process, the subjecting of the separation fraction to the reactive process effects production of the elemental form of the respective metal of at least one of the at least one recovered metal halide of the separation fraction. As a further example, where the separation fraction includes two recovered metal halides, subjecting the separation fraction to the reactive process effects production of an alloy including the respective metal of each one of the two recovered metal halides of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a coating on a substrate, wherein the coating includes the respective metal of at least one of the at least one recovered metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a metal powder net shape, wherein the net shape includes the respective metal of at least one of the at least one recovered metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, where the temperature of the heated surface is greater than the melting point of a respective metal of at least one of the at least one recovered metal halide of the separation fraction, produces metal drops which are solidified into powder form.

For example, with respect to the at least one recovered metal halide of the separation fraction, at least one of the at least one recovered metal halide of the separation fraction is disposed in a different material state than that of the metalliferrous material. As a further example, at least one of the at least one recovered metal halide of the separation fraction is disposed in at least one of a gaseous state or a liquid state, and the metalliferrous material is disposed in a solid state.

For example, with further respect to the at least one recovered metal halide, at least one operative recovered metal halide of the separation fraction is subjected to a reactive process which effects production of the elemental form of the respective metal of at least one of the at least one operative recovered metal halide, wherein each one of the at least one operative recovered metal halide is a one of the at least one recovered metal halide.

For example, with respect to the reactive process which effects production of the elemental form of the respective metal of at least one of the at least one operative recovered metal halide, the reactive process includes a decomposition reaction. For example, the decomposition reaction is effected in a plasma, such as an argon plasma characterized by a temperature of about 3000 degrees Celsius. For example the produced elemental form of the respective metal is disposed in a liquid state.

For example, with further respect to the reactive process which effects production of the elemental form of the respective metal of at least one of the at least one operative recovered metal halide, the reactive process is effected by heating the at least one operative recovered metal halide to a temperature of between about 900 degrees Celsius and about 1800 degrees Celsius.

For example, with further respect to the reactive process which effects production of the elemental form of the respective metal of at least one of the at least one operative recovered metal halide, the reactive process is effected by contacting the at least one operative recovered metal halide with a heated surface disposed at a temperature of between about 900 degrees Celsius and about 1800 degrees Celsius. For example, the heated surface is in the form of a tube, a rod, a filament, a wire, or a plasma.

For example, with further respect to the reactive process which effects production of the elemental form of the respective metal of each one of the at least one operative recovered metal halide of the separation fraction, the reactive process also effects production of at least one diatomic halogen, and at least a fraction of the at least one produced diatomic halogen is recycled to the reaction zone. For example, with respect to the at least one produced diatomic halogen, the at least one produced diatomic halogen is gaseous iodine. For example, at least a fraction of the gaseous iodine is separated from the product, and the at least a fraction of the gaseous iodine is condensed as solid iodine, and the solid iodine is recycled to the reaction zone to effect contacting with the metalliferrous material. For example, the condensing of the gaseous iodine is effected in a cold trap.

### A THIRD EMBODIMENT

In another embodiment, there is provided a process of treating a metalliferrous material including at least one target metal material fraction and at least one non-target metal material fraction. The process includes providing reagent material including at least one aluminium halide. The reagent material is contacted with the metalliferrous material in a reaction zone to effect a reactive process which effects production of an intermediate reaction product including at least one produced target metal halide. Each one of the at least one produced target metal halide includes a respective target metal corresponding to the respective target metal of a respective one of the at least one target metal material fraction. A separation fraction is separated from the intermediate reaction product, wherein the separation fraction includes at least one recovered target metal halide. For example, the reagent material further includes diatomic halogen.

In some embodiments, the halogen of each one of the at least one diatomic halogen is selected from the group consisting of iodine, bromine, and chlorine. For example, the at least one diatomic halogen is diatomic iodine.

In some embodiments, the halogen of each one of the at least one recovered metal halide corresponds to at least one of: (i) the halogen of at least one of the at least one aluminium halide, and (ii) the halogen of a one of the at least one diatomic halogen.

In some embodiments, the halogen of the aluminium halide is selected from the group consisting of iodine, bromine, and chloride. For example, the aluminium halide is aluminium iodide.

For example, with respect to the separation of the separation fraction from the intermediate reaction product, the separating of the separation fraction from the intermediate reaction product includes subjecting at least a fraction of the intermediate reaction product to a distillation process to effect production of the separation fraction. In this embodiment, the distillation process improves the purity of the at least one target metal in the separation fraction. In this respect, at least an intermediate operative fraction is provided, wherein the at least an intermediate operative fraction is the at least a fraction of the intermediate reaction product which is subjected to the distillation process, and the at least an intermediate operative fraction includes an intermediate operative target metal fraction, wherein the intermediate operative target metal fraction consists of a respective metal of each one of the at least one produced metal halide. The distillation process effects distilling of an operative separation fraction from the intermediate operative fraction, wherein the separation fraction includes the operative separation fraction, and wherein the operative separation fraction is purified in the intermediate operative target metal fraction relative to the intermediate operative fraction.

For example, with respect to the separating of the separation fraction from the intermediate reaction product, the separating a separation fraction from the intermediate reaction product includes separating at least an intermediate operative fraction from the intermediate reaction product and distilling an operative separation fraction from the intermediate operative fraction. With respect to the separating of at least an intermediate operative fraction from intermediate reaction product, the intermediate operative fraction includes an intermediate operative fraction target metal material fraction including a respective total concentration of target metal. The intermediate operative fraction target metal material fraction consists of at least one intermediate operative fraction produced metal halide. Each one of the at least one intermediate operative fraction produced metal halide is a one of the at least one produced metal halide, such that the intermediate operative fraction target metal material fraction includes at least one target metal. Each one of the at least one target metal is provided in a respective concentration within the intermediate operative fraction target metal material fraction such that at least one target metal concentration is provided within the intermediate operative fraction target metal material fraction. In this respect, the respective total concentration of target metal of the intermediate operative fraction target metal material fraction is the sum of the at least one target metal concentration provided within the intermediate operative fraction target metal material fraction. With respect to the distilling of an operative separation fraction from the intermediate operative fraction, the separation fraction includes the operative separation fraction. The operative separation fraction includes an operative separation fraction target metal material fraction including a respective total concentration of target metal. The operative separation fraction target metal material fraction consists of at least one operative separation fraction recovered metal halide. Each one of the at least one operative separation fraction recovered metal halide is a one of the at least one recovered metal halide, such that the operative separation fraction target metal material fraction includes at least one target metal. Each one of the at least one target metal is provided in a respective concentration within the operative separation fraction target metal material fraction, such that at least one target metal concentration is provided within the operative separation fraction target metal material fraction. In this respect, the respective total concentration of target metal of the operative separation fraction target metal material fraction is the sum of the at least one target metal concentration provided within the operative separation fraction target metal material fraction. The respective total concentration of target metal in the operative separation fraction target metal material fraction of the operative separation fraction is greater than the respective total concentration of target metal in the intermediate operative fraction target metal material fraction intermediate operative fraction. For example, the distilling is effected under atmospheric pressure in a distillation zone characterized by a temperature of between 230 degrees Celsius and 400 degrees Celsius.

For example, with respect to the separating of the separation fraction from the intermediate reaction product, the separation of the separation fraction from the intermediate reaction product provides a residual of the intermediate reaction product. The residual includes halogen-comprising material, and the halogen-comprising material is separated from the residual and recycled to the reaction zone. For example, the halogen-comprising material is in the form of a metal iodide in the residual. At least a fraction of the metal iodide (such as iron iodide) is separated from the residual by washing the residual with water or an organic solvent (such as an alcohol, or an aqueous alcohol solution) to effect solubilization of at least a portion of solids (including iron iodide) of the residual and produce a mixture including a liquid phase and a solid remainder including aluminium oxide. The solid remainder is separated from the mixture by a conventional solid-liquid separation process, such as mechanical filtration. The iron iodide in the liquid phase is subjected to a reactive process to effect production of gaseous iodine. For example, the reactive process is effected by contacting the liquid phase with chlorine.

For example, with further respect to the separation of the separation fraction, the separation of the separation fraction from the intermediate reaction product provides a residual of the intermediate reaction product, wherein the residual includes aluminium oxide, and wherein at least a fraction of the aluminium oxide of the residual is separated from the residual and subjected to a reactive process (such as electrolysis) to effect production of elemental aluminium, and the elemental aluminium is recycled to the reaction zone (where it is configured to be contacted by iodine to effect a reactive process which effects production of aluminium iodide).

For example, with respect to the separation of the at least a fraction of the aluminium oxide from the residual, the at least a fraction of the aluminium oxide is separated from the residual by washing with water or an organic solvent (such as an alcohol) to effect solubilization of at least a portion of the residual solid to produce a mixture including a liquid phase and a solid remainder including aluminium oxide. The solid remainder is separated from the mixture by a conventional solid-liquid separation process, such as mechanical filtration. Aluminium is then recovered from the aluminium oxide of the solid remainder, such as by way of electrolysis. The recovered aluminium is introduced to the reaction zone and converted to aluminium halide upon contacting with diatomic halogen.

For example, with respect to the contacting of the reagent with the metalliferrous material in a reaction zone to effect a reactive process which effects production of an intermediate reaction product including at least one target metal halide, the contacting of the reagent with the metalliferrous material in a reaction zone to effect a reactive process which effects production of an intermediate reaction product including at least one target metal halide includes: contacting of the at least one aluminium halide of the reagent material with the respective metal oxide material fraction of at least one operative target metal material fraction, wherein each one of the at least one operative target metal material fraction is a one of the at least one target metal material fraction, and wherein, for each one of the at least one operative target metal material fraction, the contacting of the at least one aluminium halide with the respective metal oxide material fraction of the respective one of the at least one operative target metal material fraction effects a reactive process which effects production of a respective produced metal halide, wherein the respective produced metal halide is a halide of the respective metal of the respective one of the at least one operative target metal material fraction, and wherein the respective produced metal halide is a one of the at least one produced metal halide, and wherein the halogen of the respective produced metal halide corresponds to the halogen of at least one of the at least one aluminium halide with which the contacting is being effected.

For example, the reaction zone in which the reactive process, which effects production of the intermediate reaction product, is disposed at a pressure of between about 1 bar and about 10 bar (for example, between about 1 bar and about 5 bar) and at a temperature of between about 100 degrees Celsius and about 500 degrees Celsius (for example, between about 230 degrees Celsius and about 450 degrees Celsius).

For example, the molar ratio of (i) the at least one target metal material fraction, to (ii) the at least one non-target metal material fraction, is between about 9:1 and about 1:9.

For example, with respect to the at least one aluminium halide of the reagent material, at least a fraction of the at least one aluminium halide may remain unreacted. In some embodiments of such cases, the method further includes providing at least one aluminium halide-reactive material. At least a fraction of any unreacted aluminium halide is then contacted with the at least one aluminium halide-reactive material to effect production of a relatively non-volatile aluminum material, and wherein, relative to each one of the at least one aluminum halide, the relatively non-volatile aluminum material is less volatile than at least one of the at least one aluminum halide. Each one of the at least one aluminium halide-reactive material is a halide of an element selected from either one of group I or group II of the periodic table of the elements. For example, the aluminium halide is aluminium iodide, and the provided aluminium halide-reactive material is potassium iodide, and any unreacted aluminium iodide is contacted with the potassium iodide to effect production of the relatively non-volatile aluminium material, namely, potassium aluminium iodide (KAlI₄). Relative to the aluminium iodide, potassium is less volatile than the aluminium iodide. For example, the relatively non-volative aluminium material does not substantially evaporate at pressures of between about 0.1 bar and about 1 bar and temperatures of between about 100 degrees Celsius and about 400 degrees Celsius. In this respect, in some embodiments, the at least one aluminium halide-reactive material is provided and contacted with at least a fraction of any unreacted aluminium halide prior to the distilling of the operative separation fraction from the intermediate operative fraction. For example, the at least one aluminium halide-reactive material is provided in the reaction material such that the reaction material includes the at least one aluminium halide-reactive material.

For example, with respect to the separation fraction, the separation fraction is disposed in a different material state than that of the metalliferrous material. As a further example, the separation fraction is disposed in at least one of a gaseous state or a liquid state, and the metalliferrous material is disposed in a solid state.

For example, with respect to the separation fraction, the separation fraction is subjected to a reactive process by heating the separation fraction to a temperature of between about 900 degrees Celsius and about 1800 degrees Celsius. For example, the reactive process is effected by contacting the separation fraction with a heated surface disposed at a temperature of between about 900 degrees Celsius and about 1800 degrees Celsius. For example, the heated surface is in the form of a tube, a rod, a filament, or a wire. For example, the reactive process to which the separation fraction is subjected is effected under sub-atmospheric pressure. For example, the reactive process to which the separation fraction is subjected effects production of a product form selected from the group consisting of a metallic alloy, a metallic net shape, a metallic powder or a metallic coating, wherein the product form includes the respective metal of at least one of the at least one recovered target metal halide.

For example, with respect to the subjecting of the separation fraction to the reactive process, the subjecting of the separation fraction to the reactive process effects production of the elemental form of the respective target metal of at least one of the at least one recovered target metal halide of the separation fraction. As a further example, where the separation fraction includes at least two target metal halides, subjecting the separation fraction to the reactive process effects production of an alloy including the respective target metal of each one of the at least two target metal halides of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a coating on a substrate, wherein the coating includes the respective target metal of at least one of the at least one recovered target metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a metal net shape, wherein the metal net shape includes the respective target metal of at least one of the at least one recovered target metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, where the temperature of the heated surface is greater than the melting point of a respective target metal of at least one of the at least one recovered target metal halide of the separation fraction, produces metal drops which are solidified into powder form.

For example, with respect to the at least one recovered target metal halide of the separation fraction, at least one of the at least one recovered target metal halide of the separation fraction is disposed in a different material state than that of the metalliferrous material. As a further example, at least one of the at least one recovered target metal halide of the separation fraction is disposed in at least one of a gaseous state or a liquid state, and the metalliferrous material is disposed in a solid state.

For example, with further respect to the at least one recovered target metal halide of the separation fraction, at least one operative recovered target metal halide of the separation fraction is subjected to a reactive process which effects production of the elemental form of the respective target metal of at least one of the at least one operative recovered target metal halide of the separation fraction, wherein each one of the at least one operative recovered target metal halide is a one of the at least one recovered target metal halide.

For example, with respect to the reactive process which effects production of the elemental form of the respective target metal of at least one of the at least one operative recovered target metal halide of the separation fraction, the reactive process includes a decomposition reaction. For example, the decomposition reaction is effected in a plasma, such as an argon plasma characterized by a temperature of about 3000 degrees Celsius. For example, the produced elemental form of the respective metal is disposed in a liquid state.

For example, with further respect to the reactive process which effects production of the elemental form of the respective target metal of at least one of the at least one operative recovered target metal halide of the separation fraction, the reactive process is effected by heating the at least one operative recovered target metal halide of the separation fraction to a temperature of between about 900 degrees Celsius and about 1800 degrees Celsius.

For example, with further respect to the reactive process which effects production of the elemental form of the respective target metal of at least one of the at least one operative recovered target metal halide of the separation fraction, the reactive process is effected by contacting the at least one operative recovered target metal halide of the separation fraction with a heated surface disposed at a temperature of between about 900 degrees Celsius and about 1800 degrees Celsius. For example, the heated surface is in the form of a tube, a rod, a filament, a wire, or a plasma.

For example, with further respect to the reactive process which effects production of the elemental form of the respective target metal of each one of the at least one operative recovered target metal halide of the separation fraction, the reactive process also effects production of diatomic halide, and at least a fraction of the produced diatomic halide is recycled to the reaction zone. For example, with respect to the produced diatomic halide, the produced iodine is gaseous iodine. For example, at least a fraction of the gaseous iodine is separated from the product, and the at least a fraction of the gaseous iodine is condensed as solid iodine, and the solid iodine is recycled to the reaction zone to effect contacting with the metalliferrous material. For example, the condensing of the gaseous iodine is effected in a cold trap.

### A FOURTH EMBODIMENT

In another embodiment, there is provided a process of treating a metalliferrous material including at least one target metal material fraction and at least one non-target metal material fraction. The process includes providing reaction material in a reaction zone. The reaction material includes the metalliferrous material and aluminium-comprising material, wherein the aluminium-comprising material includes aluminium. The reaction material is contacted with at least one diatomic halide to effect a reactive process to produce an intermediate reaction product including at least one produced target metal halide, wherein each one of the at least one produced target metal halide includes a respective target metal corresponding to the respective target metal of a respective one of the at least one metal material fraction. A separation fraction is separated from the intermediate reaction product, wherein the separation fraction includes at least one recovered target metal halide. For example, each one of the at least one recovered target metal halide is a one of the at least one recovered target metal halide.

In some embodiments, the halogen of each one of the at least one diatomic halogen is selected from the group consisting of iodine, bromine, and chlorine. For example, the at least one diatomic halogen is diatomic iodine.

In some embodiments, the halogen of each one of the at least one recovered metal halide corresponds to at least one of: (i) the halogen of at least one of the at least one aluminium halide, and (ii) the halogen of a one of the at least one diatomic halogen.

In some embodiments, the halogen of the aluminium halide is selected from the group consisting of iodine, bromine, and chloride. For example, the aluminium halide is aluminium iodide.

For example, with respect to the aluminium comprising material being contacted by the at least one diatomic halogen, the aluminium comprising material is in the form of particulate matter, off-cuts, or shavings. For example, any one of the particulate matter, the off-cuts, or the shavings is characterized by a diameter of less than one inch.

For example, with respect to the aluminium comprising material being contacted by the at least one diatomic halogen, the aluminium-containing material consists essentially of aluminium.

For example, with respect to the diatomic halogen contacting the aluminium containing material, the diatomic halogen is diatomic iodine which is derived from solid state iodine. For example, the solid state iodine is provided in the reaction zone. For example, with respect to the solid state iodine, the solid state iodine is in the form of a powder.

For example, with respect to the reaction material, the reaction material includes from about 30 weight % to about 95 weight % of the metalliferrous material, based on the total weight of the reaction material, and the weight of the provided iodine is from about 1% to about 5% above stoichiometric proportion, and the weight of the provided aluminium is from about 2% to about 5% above stoichiometric proportion.

For example, with respect to the separating of the separation fraction from the intermediate reaction product, the separating of the separation fraction from the intermediate reaction product includes subjecting at least a fraction of the intermediate reaction product to a distillation process to effect production of the separation fraction. In this embodiment, the distillation process improves the purity of the at least one target metal in the separation fraction. In this respect, at least an intermediate operative fraction is provided, wherein the at least an intermediate operative fraction is the at least a fraction of the intermediate reaction product which is subjected to the distillation process, and the at least an intermediate operative fraction includes an intermediate operative target metal fraction, wherein the intermediate operative target metal fraction consists of a respective metal of each one of the at least one produced metal halide. The distillation process effects distilling of an operative separation fraction from the intermediate operative fraction, wherein the separation fraction includes the operative separation fraction, and wherein the operative separation fraction is purified in the intermediate operative target metal fraction relative to the intermediate operative fraction.

For example, with respect to the separating of the separation fraction from the intermediate reaction product, the separating a separation fraction from the intermediate reaction product includes separating at least an intermediate operative fraction from the intermediate reaction product and distilling an operative separation fraction from the intermediate operative fraction. With respect to the separating of at least an intermediate operative fraction from intermediate reaction product, the intermediate operative fraction includes an intermediate operative fraction target metal material fraction including a respective total concentration of target metal. The intermediate operative fraction target metal material fraction consists of at least one intermediate operative fraction produced metal halide. Each one of the at least one intermediate operative fraction produced metal halide is a one of the at least one produced metal halide, such that the intermediate operative fraction target metal material fraction includes at least one target metal. Each one of the at least one target metal is provided in a respective concentration within the intermediate operative fraction target metal material fraction such that at least one target metal concentration is provided within the intermediate operative fraction target metal material fraction. In this respect, the respective total concentration of target metal of the intermediate operative fraction target metal material fraction is the sum of the at least one target metal concentration provided within the intermediate operative fraction target metal material fraction. With respect to the distilling of an operative separation fraction from the intermediate operative fraction, the separation fraction includes the operative separation fraction. The operative separation fraction includes an operative separation fraction target metal material fraction including a respective total concentration of target metal. The operative separation fraction target metal material fraction consists of at least one operative separation fraction recovered metal halide. Each one of the at least one operative separation fraction recovered metal halide is a one of the at least one recovered metal halide, such that the operative separation fraction target metal material fraction includes at least one target metal. Each one of the at least one target metal is provided in a respective concentration within the operative separation fraction target metal material fraction, such that at least one target metal concentration is provided within the operative separation fraction target metal material fraction. In this respect, the respective total concentration of target metal of the operative separation fraction target metal material fraction is the sum of the at least one target metal concentration provided within the operative separation fraction target metal material fraction. The respective total concentration of target metal in the operative separation fraction target metal material fraction of the operative separation fraction is greater than the respective total concentration of target metal in the intermediate operative fraction target metal material fraction intermediate operative fraction. For example, the distilling is effected under atmospheric pressure in a distillation zone characterized by a temperature of between 230 degrees Celsius and 400 degrees Celsius.

For example, with respect to the separation of the separation fraction from the intermediate reaction product, the separation of the separation fraction from the intermediate reaction product provides a residual of the intermediate reaction product. The residual includes halogen-comprising material, and the halogen-comprising material is separated from the residual and recycled to the reaction zone. For example, the halogen-comprising material is in the form of a metal iodide in the residual. At least a fraction of the metal iodide (such as iron iodide) is separated from the residual by washing the residual with water or an organic solvent (such as an alcohol, or an aqueous alcohol solution) to effect solubilization of at least a portion of solids (including iron iodide) of the residual and produce a mixture including a liquid phase and a solid remainder including aluminium oxide. The solid remainder is separated from the mixture by a conventional solid-liquid separation process, such as mechanical filtration. The iron iodide in the liquid phase is subjected to a reactive process to effect production of gaseous iodine. For example, the reactive process is effected by contacting the liquid phase with chlorine.

For example, with further respect to the separation of the separation fraction, the separation of the separation fraction from the intermediate reaction product provides a residual of the intermediate reaction product, wherein the residual includes aluminium oxide, and wherein at least a fraction of the aluminium oxide of the residual is separated from the residual and subjected to a reactive process (such as electrolysis) to effect production of elemental aluminium, and the elemental aluminium is recycled to the reaction zone (where it is configured to be contacted by iodine to effect a reactive process which effects production of aluminium iodide). For example, with respect to the separation of the at least a fraction of the aluminium oxide from the residual, the at least a fraction of the aluminium oxide is separated from the residual by washing with water or an organic solvent (such as an alcohol) to effect solubilization of at least a portion of the residual solid to produce a mixture including a liquid phase and a solid remainder including aluminium oxide. The solid remainder is separated from the mixture by a conventional solid-liquid separation process, such as mechanical filtration. Aluminium is then recovered from the aluminium oxide of the solid remainder, such as by way of electrolysis.

For example, with respect to the contacting of the diatomic halogen with the reaction material in a reaction zone to effect a reactive process which effects production of an intermediate reaction product including at least one produced target metal halide, the contacting includes:

(i) contacting of at least one operative diatomic halogen with the aluminium-comprising material to effect a reactive process which effects production of at least one aluminium halide, wherein each one of the at least one operative diatomic halogen is a one of the at least one diatomic halogen; and
(ii) contacting of at least one operative aluminium halide with the respective metal oxide material fraction of at least one operative target metal material fraction, wherein each one of the at least one operative target metal material fraction is a one of the at least one target metal material fraction, and wherein each one of the at least one operative aluminium halide is a one of the at least one aluminium halide, and wherein, for each one of the at least one operative target metal material fraction, at least one of the at least one operative aluminium halide is contacted with the respective metal oxide material fraction of the respective one of the at least one operative target metal material fraction to effect a reactive process which effects production of a respective target metal halide, wherein the respective target metal halide is a halide of the respective target metal of the respective one of the at least one operative target metal material fraction, and wherein the respective produced target metal halide is a one of the at least one produced target metal halide, and wherein the halogen of the respective produced target metal halide corresponds to the halogen of at least one of the at least one of the aluminium halide with which the contacting is being effected.

For example, the reaction zone in which the reactive process, which effects production of the intermediate reaction product, is disposed at a pressure of between about 1 bar and about 10 bar (for example, between about 1 bar and about 5 bar) and at a temperature of between about 100 degrees Celsius and about 500 degrees Celsius (for example, between about 230 degrees Celsius and about 450 degrees Celsius).

For example, the molar ratio of (i) the at least one target metal material fraction, to (ii) the at least one non-target metal material fraction, is between about 9:1 and about 1:9.

For example, with respect to the at least one produced aluminium halide, at least a fraction of the at least one produced aluminium halide may remain unreacted. In this respect, the above-described the at least one aluminum halide-reactive material is provided. At least a fraction of any unreacted aluminium iodide is contacted with the at least one aluminium halide-reactive material to effect production of a relatively non-volatile aluminium material. Each one of the at least one aluminium halide-reactive material is a halide of a respective element selected from either one of group I or group II of the periodic table of the elements. For example, the unreacted at least one aluminium halide is aluminium iodide and the aluminium halide-reactive material is potassium iodide. The aluminium halide is contacted with the potassium iodide to effect production of potassium aluminium iodide (KAlI₄), which is an example of the relatively non-volatile aluminium material. Relative to the aluminium iodide, potassium aluminium iodide is less volatile than the aluminium iodide. For example, the relatively non-volative aluminium material does not substantially evaporate at pressures of between about 0.1 bar and about 1 bar and temperatures of between about 100 degrees Celsius and about 400 degrees Celsius. In this respect, in some embodiments, the at least one aluminium halide-reactive material is provided and contacted with at least a fraction of any unreacted aluminium halide prior to the distilling of the operative separation fraction from the intermediate operative fraction. For example, the at least one aluminium halide-reactive material is provided in the reaction material such that the reaction material includes the at least one aluminium halide-reactive material.

For example, with respect to the separation fraction, the separation fraction is disposed in a different material state than that of the metalliferrous material. As a further example, the separation fraction is disposed in at least one of a gaseous state or a liquid state, and the metalliferrous material is disposed in a solid state.

For example, with respect to the separation fraction, the separation fraction is subjected to a reactive process by heating the separation fraction to a temperature of between about 900 degrees Celsius and about 1800 degrees Celsius. For example, the reactive process is effected by contacting the separation fraction with a heated surface disposed at a temperature of between about 900 degrees Celsius and about 1800 degrees Celsius. For example, the heated surface is in the form of a tube, a rod, a filament, or a wire. For example, the reactive process to which the separation fraction is subjected is effected under sub-atmospheric pressure. For example, the reactive process to which the separation fraction is subjected effects production of a product form selected from the group consisting of a metallic alloy, a metallic net shape, a metallic powder or a metallic coating, wherein the product form includes the respective metal of at least one of the at least one target metal iodide material

For example, with respect to the subjecting of the separation fraction to the reactive process, the subjecting of the separation fraction to the reactive process effects production of the elemental form of the respective target metal of at least one of the at least one recovered target metal halide of the separation fraction. As a further example, where the separation fraction includes at least two target metal halides, subjecting the separation fraction to the reactive process effects production of an alloy including the respective target metal of each one of the two target metal halides of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a coating on a substrate, wherein the coating includes the respective target metal of at least one of the at least one recovered target metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, effects production of a metal net shape, wherein the metal net shape includes the respective target metal of at least one of the at least one recovered target metal halide of the separation fraction.

As a further example, with respect to the subjecting of the separation fraction to the reactive process by contacting the separation fraction with a heated surface disposed at a temperature of between about 900 degrees Celsius and about 1800 degrees Celsius, the subjecting of the separation fraction to the reactive process, by contacting the separation fraction with a heated surface disposed at a temperature of between about 900 degrees Celsius and about 1800 degrees Celsius, where the temperature of the heated surface is greater than the melting point of a respective target metal of at least one of the at least one recovered target metal halide of the separation fraction, produces metal drops which are solidified into powder form.

For example, with respect to the at least one target metal halide of the separation fraction, at least one of the at least one recovered target metal halide of the separation fraction is disposed in a different material state than that of the metalliferrous material. As a further example, at least one of the at least one target recovered metal halide of the separation fraction is disposed in at least one of a gaseous state or a liquid state, and the metalliferrous material is disposed in a solid state.

For example, with further respect to the at least one target metal iodide material of the separation fraction, at least one operative recovered target metal halide of the separation fraction is subjected to a reactive process which effects production of the elemental form of the respective target metal of at least one of the at least one operative recovered target metal halide of the separation fraction, wherein each one of the at least one operative recovered target metal halide is a one of the at least one recovered target metal halide.

For example, with respect to the reactive process which effects production of the elemental form of the respective target metal of at least one of the at least one operative recovered target metal halide of the separation fraction, the reactive process includes a decomposition reaction. For example, the decomposition reaction is affected in a plasma, such as an argon plasma characterized by a temperature of about 3000 degrees Celsius. For example, the produced elemental form of the respective metal is disposed in a liquid state.

For example, with further respect to the reactive process which effects production of the elemental form of the respective target metal of at least one of the at least one operative recovered target metal halide of the separation fraction, the reactive process is effected by heating the at least one operative recovered target metal halide of the separation fraction to a temperature of between about 900 degrees Celsius and about 1800 degrees Celsius.

For example, with further respect to the reactive process which effects production of the elemental form of the respective target metal of at least one of the at least one operative recovered target metal halide of the separation fraction, the reactive process is effected by contacting the at least one operative recovered target metal halide of the separation fraction with a heated surface disposed at a temperature of between about 900 degrees Celsius and about 1800 degrees Celsius. For example, the heated surface is in the form of a tube, a rod, a filament, a wire, or a plasma.

For example, with further respect to the reactive process which effects production of the elemental form of the respective target metal of each one of the at least one operative recovered target metal halide of the separation fraction, the reactive process also effects production of at least one diatomic halogen, and at least a fraction of the produced at least one diatomic halogen, is recycled to the reaction zone. For example, with respect to the produced at least one diatomic halogen, the produced at least one diatomic halogen is gaseous iodine. For example, at least a fraction of the gaseous iodine is separated from the product, and the at least a fraction of the gaseous iodine is condensed as solid iodine, and the solid iodine is recycled to the reaction zone to effect contacting with the metalliferrous material. For example, the condensing of the gaseous iodine is effected in a cold trap.

### A FIFTH EMBODIMENT

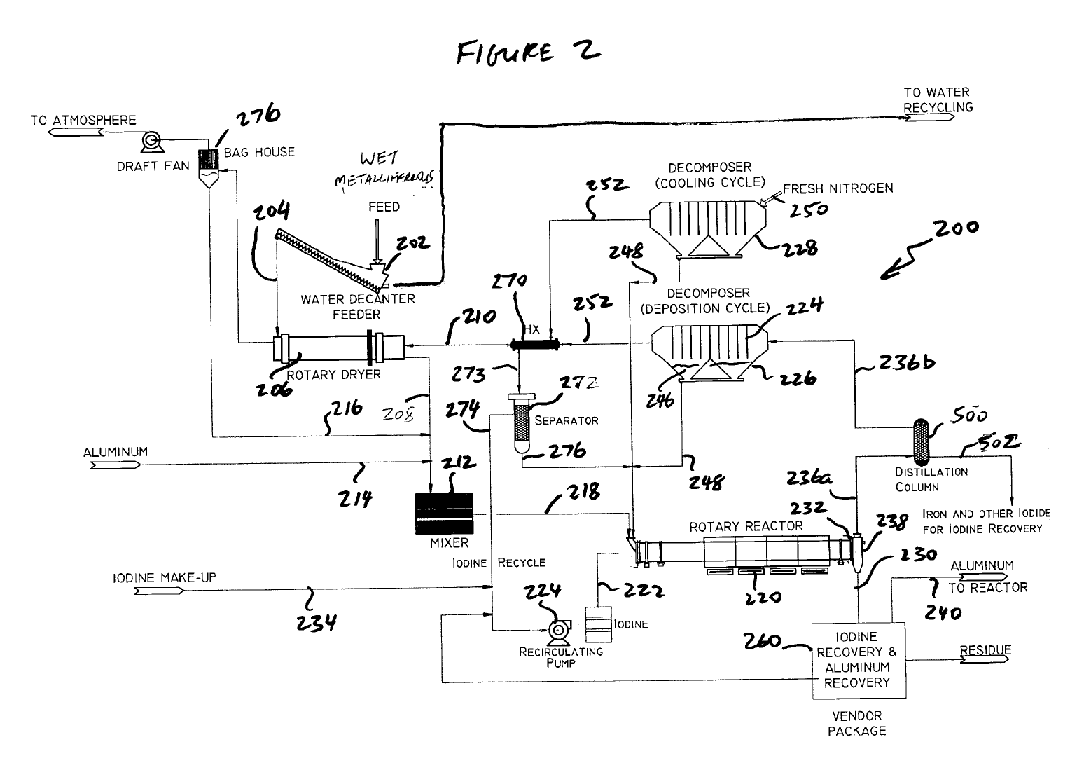

Referring to FIG. 2, there is provided a system 200 for effecting a process for treating the metalliferrous material including a target metal (such as titanium), as explained in some of the embodiments and examples described above.

The metalliferrous feed, in the form of a slurry 204, is introduced to the system 200 through a screw conveyor 202. The metalliferrous feed slurry 204 is flowed through a rotary dryer 206 to remove excess moisture to produce a dried metalliferrous feed slurry 208. The metalliferrous feed slurry 204 is dried using pre-heated gaseous flow 210 which is provided from another unit operation in the system 200, as will be further described below.

The dried metalliferrous feed slurry 208 is introduced into a mixer 212, and admixed with the aluminium-containing material 214 and metalliferrous residue 216. The metalliferrous residue 216 is provided from another unit operation 276 in the system 200, as will be further described below. The aluminium-containing material can be introduced to the mixer 212 with a screw conveyor. Upon admixing, the reaction material 218 is discharged from the mixer 212 and introduced into a rotary reactor 220 by gravity discharge.

The reaction material 218 is contacted with the iodine in the rotary reactor 220. The iodine is provided as a liquid flow 222 by a blower 224. The source of the liquid flow 222 of iodine includes iodine recycled from at least one of decomposers 226, 228, as will be further described below. The source of the liquid flow 222 of iodine also includes iodine recycled from the flow the residual 230 of the intermediate reaction product 232 being discharged from the rotary reactor 220, as will be further described below. Additionally, the source of the liquid flow 222 of iodine includes iodine make-up 234.

As mentioned above, the reaction material 218 is contacted with the iodine in the rotary reactor 220, and this contacting effects a reactive process which effects production of the intermediate reaction product 232. The temperature inside the reactor 220 is between about 100 degrees Celsius and about 500 degrees Celsius (for example, between about 230 degrees Celsius and about 450 degrees Celsius). The pressure inside the reactor 220 is between about 1 bar and about 10 bar (for example, between about 1 bar and about 5 bar. The separation fraction 236a is separated from the intermediate reaction product 232, leaving the residual 230. The separation fraction 236a, in a liquid state, is separated from the intermediate reaction product 232 by way of a solid-liquid separator 238, such as by way of gravity separation. In some cases, potassium iodide (or any other metal halide-reactive material) is introduced to the rotary reactor 220, and the introduced potassium iodide is contacted with any unreacted aluminium iodide (or any other aluminium halide) to thereby effect production of potassium aluminium iodide (and thereby effect conversion of the unreacted aluminium halide to potassium aluminium iodide) which is less volatile than the aluminium iodide of the unreacted aluminium halide. If the unreacted aluminium iodide is permitted to be processed downstream in the distillation column 500, the aluminium of the unreacted aluminium iodide could be included in the gaseous separation fraction being discharged from the distillation column 500 and being introduced to the decomposers 226, 228, and thereby compromise product purity of the metal product being produced in the decomposers 226, 228. By converting the aluminium iodide of the unreacted aluminium iodide to the relatively less volatile potassium aluminium iodide, product purity is enhanced, as the relatively less volatile potassium aluminium iodide is less volatile, which means that aluminium of the relatively less volatile potassium aluminium iodide does not or is unlikely to report to the decomposers 226, 228.

The residual 230 is treating in a unit operation 260 which effect iodine recovery and aluminium recovery.

The residual 230 includes aluminium oxide, and the aluminium oxide is subjected to a reactive process to effect production of aluminium 240. For example, at least a fraction of the aluminium oxide is separated from the residual by washing the residual with water or an organic solvent (such as an alcohol, or an aqueous alcohol solution) to effect solubilization of at least a portion of solids of the residual and produce a mixture including a liquid phase and a solid remainder including aluminium oxide. The solid remainder is separated from the mixture by a conventional solid-liquid separation process, such as mechanical filtration. Aluminium is then recovered from the aluminium oxide of the solid remainder, such as by way of electrolysis. The produced aluminium 240 is then recycled to the mixer 212.

The residual 230 also includes iodine, and the iodine is separated from the residual and recycled to the suction of the blower 224. For example, the iodine is in the form of a metal iodide in the residual. At least a fraction of he metal iodide (such as iron iodide) is separated from the residual by washing the residual with water or an organic solvent (such as an alcohol, or an aqueous alcohol solution) to effect solubilization of at least a portion of solids (including iron iodide) of the residual and produce a mixture including a liquid phase and a solid remainder including aluminium oxide. The solid remainder is separated from the mixture by a conventional solid-liquid separation process, such as mechanical filtration. The iron iodide in the liquid phase is subjected to a reactive process to effect production of gaseous iodine. For example, the reactive process is effected by contacting the liquid phase with chlorine.

The separation fraction 236a is introduced into a distillation column 500 where the separation fraction 236a is fractionated to produce a treated separation fraction 236b and a relatively non-volatile residue 502. Distillation is effected in a distillation zone of the distillation column 500 under atmospheric pressure and at a temperature of between 230 degrees Celsius and 400 degrees Celsius. A distillation process for, generally, fractionating a gaseous mixture of metals, is described in International Patent Publication No. 96/20892 (published International Application No. PCT/US95/04870). The treated separation fraction 236b is purified in the target metal relative to the separation fraction 236a. The relatively non-volatile residue 502 includes iron and other relatively non-volatile halides (relative to the target metal halide(s)). The residue can be further processed for iodine recovery and thereby function as source of iodine for iodine flow 222.

The separation fraction 236b is flowed and introduced into one of the decomposers 226, 228. Typically, only one of the decomposers 226, 228 is in fluid communication with the separation fraction flow 236b at any given time for purposes of subjecting the separation fraction 236b to a reactive process including a decomposition reaction. While the separation fraction 236b is being subjected to the reactive process in one of the decomposers 226, 228, the other one of the decomposers 226, 228 is off-line so as to facilitate recovery of decomposition product. When the separation fraction 236b is being subjected to the reactive process in one of the decomposers, the respective one of the decomposers 226, 288 is said to be in a deposition cycle.

After discharging from the distillation column 500, the separation fraction 236b is introduced into one of the decomposers 226, 228 either in the liquid state or the gaseous state or a combination thereof. If introduced in the liquid state, the separation fraction 236b must be cooled (such as by a heat exchanger) after discharging from the distillation column 500 and prior to introduction to one of the decomposers 226, 228.

The conduit which effects fluid communication between the separator 238 and each one of the decomposers 226, 228 is heat traced so as to ensure that there is no undesired change in state of either one of the separation fraction 236a or the separation fraction 236b.

During the deposition cycle, once introduced into one of the decomposers 226, 228, the separation fraction 236b is exposed to a high temperature, sub-atmospheric environment in the reaction zone 242 of the respective one of the decomposers 226, 228. The temperature of the reaction zone 242 is from about 900 degrees Celsius to about 1800 degrees Celsius, and this is effected by heated tungsten filaments 244 disposed within the reaction zone 242. Metal iodide material of the separation fraction 236b evaporates and is transported to the heated tungsten filaments 244. Upon contact with the heated tungsten filaments 244, the metal iodide material is subjected to a reactive process which effects decomposition of the metal iodide material, and thereby effects production of metal product. The metal product can be any one, or any combination of elemental metal material or metal alloy material. The metal product can be formed as a coating on a substrate, or can be formed into a net shape, such as a rod.

Still during the deposition cycle (in the illustrated example of FIG. 2, decomposer 226 is in the deposition cycle), overflow of liquid including unreacted metal iodide is drained as liquid flow 248. The liquid flow 248 is recycled through the rotary reactor 220. The conduit effecting fluid communication between the respective one of the decomposers 228 for effecting the draining of the residual liquid flow 248, is heat traced to maintain the residual liquid flow 248 in a liquid state. Also, exhausted gases including unreacted metal iodide and iodine gas is flowed as fluid flow 252 to one of the compartments of the heat exchanger 270, The fluid flow 252 is flowed through a conduit which may be heat traced to maintain temperature at least about 200 degrees Celsius and thereby mitigate condensation and sublimation of the metal iodide. In passing through the heat exchanger 270, the metal iodide is condensed, and the fluid flow 252 discharges as flow 273 from the heat exchanger 270 and includes condensed liquid metal iodide and iodine vapour. The flow 273 is flowed through a gas-liquid separator 272. The gas-liquid separator 272 separates the flow 273 into a gaseous iodine flow 274 and a liquid flow 276 including metal iodide. The flow 274 is directed to the suction of the blower 224 (or pump). The liquid flow 276 is directed to the rotary reactor 220.

Upon realizing a predetermined weight of the metal product, flow of the separation fraction 236 to the respective one of the decomposers 226, 228 is stopped, and heat is then no longer applied to the filaments 244. The respective one of the decomposers 226, 228 is now disposed in a product recovery mode and enters into the cooling cycle. In the illustrated example in FIG. 2, the decomposer 228 is disposed in the cooling cycle. The flow of the separation fraction 236b is then diverted to the other one of the decomposers 226, 228, and the reactive process is similarly effected.

When in the cooling cycle (see decomposer 228 in FIG. 2), residual liquid product 246 is drained from the respective one of the decomposers 226, 228 as residual liquid flow 248. The residual liquid flow 248 includes undecomposed metal iodide. The residual liquid flow 248 is recycled through the rotary reactor 220. The conduit effecting fluid communication between the respective one of the decomposers 228 for effecting the draining of the residual liquid flow 248, is heat traced to maintain the residual liquid flow 248 in a liquid state.

After the residual liquid product 246 has been drained from the respective one of the decomposers 226, 228, the respective one of the decomposers 226, 228 is purged with a nitrogen purge gas flow 250. Amongst other things, this effects cooling of the respective one of the decomposers 226, 228.

The nitrogen gas purge flow 250 flows through the respective one of the decomposer 226, 228 and is discharged from the respective one of the decomposers 226, 228 as heated gaseous discharge 252. The heated gaseous discharge 252 includes nitrogen, residual liquid product 246 including metal iodide, metal dust, and iodine. The conduit which flows the discharge 252 is heat traced to mitigate condensation or sublimation of iodide. The heated gaseous discharge 252 is flowed through the heat exchanger 270 to effect desired cooling of the heated gaseous discharge 252. The temperature of the fluid flow 252 is reduced to about 120 degrees Celsius after passing through the heat exchanger 270, and this effects condensation of the liquid iodide which drains from the heat exchanger to the gas/liquid separator 272. The fluid flow 252, therefore, is separated into a liquid flow 273 and a gaseous flow 210. The flow 210, at about 120 degrees Celsius is flowed to the dryer to effect drying of the feed slurry 205 and is discharged to a bag house 276 to effect separation and recovery of any metal dust which becomes metalliferrous residue 216. The gas/liquid separator separates the incoming fluid 273 into a gaseous iodine flow 274 and a liquid flow 276 including metal iodide. The flow 274 is directed to the suction of the blower 224 (or pump). The liquid flow 276 is directed to the rotary reactor 220.

The invention will be further described with reference to the following non-limitative examples.

### EXAMPLES

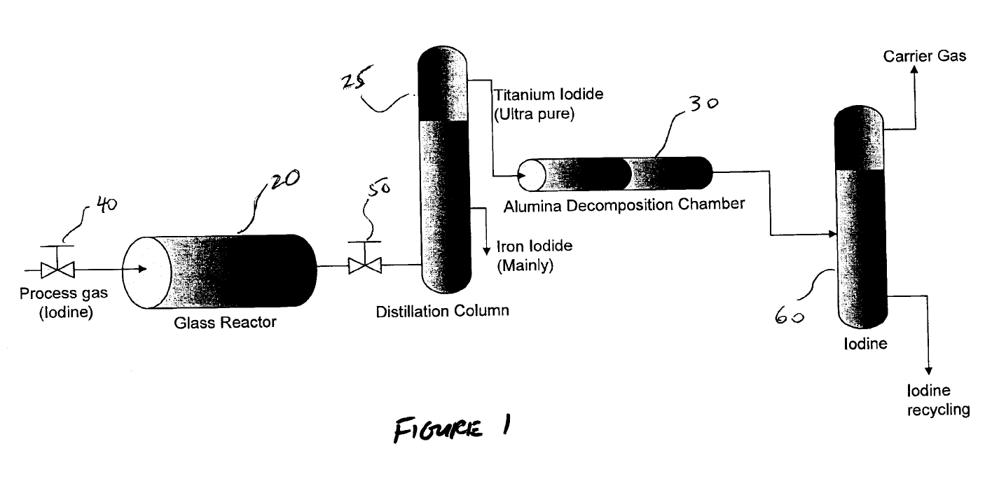

Several examples were carried out using the testing apparatus 10 illustrated in FIG. 1. The testing apparatus 10 includes a glass pressure reactor vessel 20, a distillation column 25, an alumina tube decomposition chamber 30, two isolation glass valves 40, 50, and an iodine scrubber 60 (which has been cooled down to minus 70 degrees Celsius with dry ice) which functions as a cold trap.

### Example No. 1

100 g of impure Ti metal (85% Ti metal and 15% Ti in the form of TiO₂) was mixed with 1100 g of solid iodine. The reactor vessel 20 was purged with argon to remove oxygen and vessel was sealed. Temperature was slowly increased to 200° C. and the reactor vessel 20 was allowed to stay at this temperature for 1 hour. After reaction was complete, the reactor isolation valve 50 was open to the distillation column. The distillation column was a single state distillation column operated at a temperature of 400 degrees Celsius and at atmospheric pressure, and was used to effect fractionation of the reaction product produced within and discharged from the reactor vessel 20, and thereby deliver a treated reaction product purified in the target metal to the decomposition chamber 30. The decomposition chamber 30 includes an alumina tube decomposer disposed at a temperature of 1500° C. (See FIG. 1). Argon gas was introduced in to reactor (50 cc/min) using isolation valve 40. The system was purged with Argon flow for 1 hour. Resulting iodine was collected in iodine scrubber 60 and recycled. When all TiI₄ was transferred into decomposition chamber 30, as evidenced by a pre-determined weight loss in the reaction vessel measured by a weight cell, the decomposition chamber 30 was cooled down under argon flow to room temperature. Pure titanium tube was separated from decomposition chamber 30 and weighed. Yield 84.4% (84.4 g of Titanium metal)

### Example No. 2

100 g of impure Ti metal (85% Ti metal and 15% TiO₂) was mixed with 1100 g of Iodine and 6 g of Aluminum metal powder. The reactor vessel 20 was purged with argon to remove oxygen and the vessel 20 was sealed. Temperature was slowly increased to 200° C. and the reactor 20 was maintained at this temperature for 1 hour. After reaction was complete, reactor isolation valve 50 was open to the distillation column 25 and the decomposition chamber 30. The decomposition chamber 30 included a tube decomposer disposed at a temperature of 1500° C. (See FIG. 1). Argon gas was introduced in to reactor (50 cc/min) using isolation valve 40. The system was purged with Argon flow for 1 hour. Resulting iodine was collected in iodine scrubber 60 and recycled. When all TiI₄ was transferred into decomposition chamber 30, the decomposition chamber 30 was cooled down under Argon flow to room temperature. Pure titanium tube was separated from decomposition chamber and weighted. Yield 98% (92.1 g of Titanium metal)

### Example No. 3

200 g of Ilminite (FeTiO₃), 48 g of aluminum powder, and 680 g of iodine were used as the reactant material. The reactor 20 was purged, isolated and heated as described in Example No. 2. The resulting TiI₄ was decomposed using above procedure resulting in 61 g of titanium tube (97% yield).

### Example No. 4

The same procedure as in Example No. 2, with the exception that the reactant material consisted of 100 g of impure Zirconium metal (82% Zr and 18% ZrO₂), 5.5 g of aluminum powder, and 540 g of I₂ were used as the reactant material. Yield 99% (95.1 g of Zr metal)

### Example No. 5

The same procedure as in Example No. 2, with the exception that the reactant material consisted of 100 g of impure Hafnium metal (79% Hf and 21% HfO₂), 3.7 g of aluminum powder, and 280 g of iodine were used as the reactant material. Yield 98% (94.9 g of Hf metal).

### Example No. 6

The same procedure as in Example No. 2, with the exception that the reactant material consisted of 100 g of impure Niobium metal (95% pure Nb and 5% Nb₂O₅), 1.8 g of aluminum powder, and 670 g of iodine were used as the reactant material. Yield 97% (94.8 g of Nb metal).

### Example No. 7

The same procedure as in Example No. 2, with the exception that the reactant material consisted of 100 g of impure Tantalum metal (50% pure Ta and 50% Ta₂O₅). 11 g of aluminum powder, and 290 g of iodine. Yield 95% (80.5 g of Ta metal).

While this invention has been described with reference to illustrative embodiments and examples, the description is not intended to be construed in a limiting sense. Thus, various modification of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

### REFERENCES

1. A. E. van Arkel and J. H. Boer, U.S. Pat. No. 1,671,213, May 29, 1928; A. E. van Arkel and J. H. Boer , Z. anorg. U. allgem. Chem., 148, 345-350.
2. R. F. Rolsten, “Iodide Metals and Metal iodides”, John Wiley & Sons, Inc. 1961.
3. I. E. Campbell, R. I. Jaffee, J. M. Blocher, Jr., J. Gurland, and B. W. Gonser, J. Electrochem. Soc., 93, No 6, 271-285 (1948).
4. A. W. Petersen and L. A. Bromley, J. Metals, 8, Trans. A.I.M.E. 206, 284-286 (1956).
5. W. O. DiPietro, G. R. Findlay, and J. H. Moore, National Research Corp., AECD-3276, Final Report, Dec. 30, 1948 through May 20, 1950.
6. M. Chaigneau, Bull.soc.chim.France, 1957, 886-888

1-210. (canceled)

211. A process of treating a metalliferrous material including a target metal material fraction, wherein the target metal material fraction includes a transitional metal, and wherein the target metal material fraction includes a first operative material fraction and a second operative material fraction, and wherein the first operative material fraction consists of an elemental form of the transition metal, and wherein the second operative material fraction consists of at least one oxide of the transition metal, comprising:
providing reagent material including a diatomic halogen and an aluminium halide;
contacting the reagent material with the metalliferrous material in a reaction zone so as to effect a reactive process which effects production of an intermediate reaction product including a produced metal halide, and wherein the produced metal halide is a halide of the transition metal.
separating a separation fraction from the intermediate reaction product, wherein the separation fraction includes at least one recovered metal halide, wherein the recovered metal halide is at least a fraction of the produced metal halide;
wherein the halogen of the recovered metal halide corresponds to the halogen of the aluminium halide.

212. The process as claimed in claim 211, wherein separation of the separation fraction from the intermediate reaction product provides a residual of the intermediate reaction product, wherein the residual includes aluminium oxide; and further comprising:
subjecting at least a fraction of the aluminium oxide of the residual to a reactive process to effect production of elemental aluminium; and
recycling the produced elemental aluminium to the reaction zone.

213. The process as claimed in claim 211, wherein separation of the separation fraction from the intermediate reaction product provides a residual of the intermediate reaction product, wherein the residual includes aluminum-comprising material, and wherein at least a fraction of the aluminum-comprising material of the residual is separated from the residual, converted to diatomic halogen and recycled to the reaction zone.

214. The process as claimed in claim 211, further comprising:
providing an aluminum halide-reactive material; and
contacting at least a fraction of any unreacted aluminium halide with the aluminium halide-reactive material to effect production of a relatively non-volatile aluminum material, and wherein, relative to the aluminum halide, the relatively non-volatile aluminum material is less volatile than the aluminum halide;
wherein the aluminium halide-reactive material is a halide of an element selected from either one of group I or group II of the periodic table of the elements.

215. The process as claimed in claim 211, wherein the separating a separation fraction from the intermediate reaction product includes:
separating at least an intermediate operative fraction from the intermediate reaction product, wherein the intermediate operative fraction includes an intermediate operative fraction target metal material fraction including a respective concentration of target metal, wherein the intermediate operative fraction target metal material fraction consists of the produced metal halide, such that the intermediate operative fraction target metal material fraction includes the target metal, wherein the target metal is provided in a respective concentration within the intermediate operative fraction target metal material fraction which defines the respective concentration of target metal in the intermediate operative fraction target metal material fraction; and
distilling an operative separation fraction from the intermediate operative fraction, wherein the separation fraction includes the operative separation fraction, and wherein the operative separation fraction includes an operative separation fraction target metal material fraction including a respective concentration of target metal, wherein the operative separation fraction target metal material fraction consists of the recovered metal halide, such that the operative separation fraction target metal material fraction includes the target metal, wherein the target metal is provided in a respective concentration within the operative separation fraction target metal material fraction which defines the respective concentration of target metal in the operative separation fraction target metal material fraction;
wherein the respective concentration of target metal in the operative separation fraction target metal material fraction of the operative separation fraction is greater than the respective concentration of target metal in the intermediate operative fraction target metal material fraction of the intermediate operative fraction.

216. The process as claimed in claim 211, wherein at least a fraction of the recovered metal halide is subjected to a reactive process which effects production of the elemental form of the transition metal.

217. The process as claimed in claim 216, wherein the reactive process, which effects production of the elemental form of the transition metal, also effects production of diatomic halogen;
and further comprising recycling at least a fraction of the produced diatomic halogen to the reaction zone.

218. A process of treating a metalliferrous material including a target metal material fraction, wherein the target metal material fraction includes a transition metal, and wherein the target metal material fraction includes a first operative material fraction and a second operative material fraction, wherein the first operative material fraction consists of an elemental form of the transition metal and the second operative material fraction consists of at least one oxide of the transition metal, comprising:
providing reaction material in a reaction zone, wherein the reaction material includes the metalliferrous material and aluminium-comprising material, wherein the aluminium-comprising material includes aluminium;
contacting the reaction material with diatomic halogen to effect a reactive process which effects production of an intermediate reaction product including a produced metal halide, and wherein the produced metal halide includes the transitional metal; and
separating a separation fraction from the intermediate reaction product, wherein the separation fraction includes a recovered metal halide, wherein the recovered metal halide is at least a fraction of the produced metal halide.

219. The process as claimed in claim 218,
wherein separation of the separation fraction from the intermediate reaction product provides a residual of the intermediate reaction product, wherein the residual includes aluminium oxide;
and further comprising:
subjecting at least a fraction of the aluminium oxide of the residual to a reactive process to effect production of elemental aluminium; and
recycling the produced elemental aluminium to the reaction zone.

220. The process as claimed in claim 218, wherein separation of the separation fraction from the intermediate reaction product provides a residual of the intermediate reaction product, wherein the residual includes halogen-comprising material, and wherein at least a fraction of the halogen-comprising material of the residual is separated from the residual, converted to diatomic halogen, and recycled to the reaction zone.

221. The process as claimed in claim 218, further comprising:
providing an aluminum halide-reactive material; and
contacting at least a fraction of any unreacted aluminium halide with the aluminium halide-reactive material to effect production of a relatively non-volatile aluminum material, and wherein, relative to the aluminum halide, the relatively non-volatile aluminum material is less volatile than the aluminum halide;
wherein the aluminium halide-reactive material is a halide of an element selected from either one of group I or group II of the periodic table of the elements.

222. The process as claimed in claim 218, wherein the separating a separation fraction from the intermediate reaction product includes:
separating at least an intermediate operative fraction from the intermediate reaction product, wherein the intermediate operative fraction includes an intermediate operative fraction target metal material fraction including a respective concentration of target metal, wherein the intermediate operative fraction target metal material fraction consists of the produced metal halide, such that the intermediate operative fraction target metal material fraction includes the target metal, wherein the target metal is provided in a respective concentration within the intermediate operative fraction target metal material fraction which defines the respective concentration of target metal in the intermediate operative fraction target metal material fraction; and
distilling an operative separation fraction from the intermediate operative fraction, wherein the separation fraction includes the operative separation fraction, and wherein the operative separation fraction includes an operative separation fraction target metal material fraction including a respective concentration of target metal, wherein the operative separation fraction target metal material fraction consists of the recovered metal halide, such that the operative separation fraction target metal material fraction includes the target metal, wherein the target metal is provided in a respective concentration within the operative separation fraction target metal material fraction which defines the respective concentration of target metal in the operative separation fraction target metal material fraction;
wherein the respective concentration of target metal in the operative separation fraction target metal material fraction of the operative separation fraction is greater than the respective concentration of target metal in the intermediate operative fraction target metal material fraction of the intermediate operative fraction.

223. The process as claimed in claim 218, wherein at least a fraction of the recovered metal halide is subjected to a reactive process which effects production of the elemental form of the transition metal.

224. The process as claimed in claim 223, wherein the reactive process, which effects production of the elemental form of the transition metal, also effects production of diatomic halogen;
and further comprising recycling at least a fraction of the diatomic halogen to the reaction zone.

225. A process of treating a metalliferrous material including a target metal material fraction and a non-target metal material fraction, wherein the target metal material fraction includes a respective target metal, and the respective target metal is a transition metal, and wherein the target metal material fraction includes a metal oxide material fraction, and the respective metal oxide material fraction consists of an oxide of the respective target metal, and wherein the non-target metal material fraction includes a respective non-target metal, and wherein the halide of the respective target metal of the target metal material fraction is relatively more volatile than the halide of the respective non-target metal of the non-target metal material fraction, comprising:
providing reagent material including aluminium halide;
contacting the reagent material with the metalliferrous material in a reaction zone so as to effect a reactive process which effects production of an intermediate reaction product including a produced target metal halide, and wherein the produced target metal halide includes a respective target metal corresponding to the respective target metal of the target metal material fraction; and
separating a separation fraction from the intermediate reaction product, wherein the separation fraction includes a recovered target metal halide, wherein the recovered target metal halide is produced target metal halide.

226. The process as claimed in claim 225, wherein the separating a separation fraction from the intermediate reaction product includes:
separating at least an intermediate operative fraction from the intermediate reaction product, wherein the intermediate operative fraction includes an intermediate operative fraction target metal material fraction including a respective concentration of target metal, wherein the intermediate operative fraction target metal material fraction consists of the produced metal halide, such that the intermediate operative fraction target metal material fraction includes the target metal, wherein the target metal is provided in a respective concentration within the intermediate operative fraction target metal material fraction which defines the respective concentration of target metal in the intermediate operative fraction target metal material fraction; and
distilling an operative separation fraction from the intermediate operative fraction, wherein the separation fraction includes the operative separation fraction, and wherein the operative separation fraction includes an operative separation fraction target metal material fraction including a respective concentration of target metal, wherein the operative separation fraction target metal material fraction consists of the recovered metal halide, such that the operative separation fraction target metal material fraction includes the target metal, wherein the target metal is provided in a respective concentration within the operative separation fraction target metal material fraction which defines the respective concentration of target metal in the operative separation fraction target metal material fraction;
wherein the respective concentration of target metal in the operative separation fraction target metal material fraction of the operative separation fraction is greater than the respective concentration of target metal in the intermediate operative fraction target metal material fraction of the intermediate operative fraction.

227. The process as claimed in claim 226, further comprising, prior to the distilling:
providing aluminium halide-reactive material; and
contacting at least a fraction of any unreacted aluminium halide with the aluminium halide-reactive iodide material to effect production of a relatively non-volatile aluminium material, and wherein, relative to the aluminium halide, the relatively non-volatile aluminium material is less volatile than the aluminium halide, wherein the aluminium halide-reactive material is a halide of a respective element selected from either one of group I or group II of the periodic table of the elements.

228. A process of treating a metalliferrous material including a target metal material fraction and a non-target metal material fraction, wherein the target metal material fraction includes a respective target metal, and the respective target metal is a transition metal, and wherein the target metal material fraction includes a respective metal oxide material fraction, and the respective metal oxide material fraction consists of an oxide of the respective target metal, and wherein the non-target metal material fraction includes a respective non-target metal, and wherein the halide of the respective target metal of the target metal material fraction is relatively more volatile than the halide of the respective non-target metal of the non-target metal material fraction, comprising:
providing reaction material in a reaction zone, wherein the reaction material includes the metalliferrous material and aluminium-comprising material, wherein the aluminium-comprising material includes aluminium;
contacting the reaction material with diatomic halogen to effect a reactive process to produce an intermediate reaction product including produced target metal halide, wherein the produced target metal halide material includes a respective target metal corresponding to the respective target metal of the target metal material fraction; and
separating a separation fraction from the intermediate reaction product, wherein the separation fraction includes recovered target metal halide, wherein the recovered target metal halide is the produced target metal halide.

229. The process as claimed in claim 228, wherein separation of the separation fraction from the intermediate reaction product provides a residual of the intermediate reaction product, wherein the residual includes aluminium oxide, and wherein at least a fraction of the aluminium oxide of the residual is subjected to a reactive process to effect production of elemental aluminium, wherein the elemental aluminium is recycled to the reaction zone.

230. The process as claimed in claim 228, wherein separation of the separation fraction from the intermediate reaction product leaves a residual of the intermediate reaction product, wherein the residual includes diatomic halogen, and wherein at least a fraction of the diatomic halogen of the residual is separated from the residual and recycled to the reaction zone.

231. The process as claimed in claim 228, further comprising:
providing aluminium halide-reactive material;
contacting at least a fraction of any unreacted aluminium halide is with the aluminium iodide-reactive material to effect production of a relatively non-volatile aluminium material, and wherein, relative to the aluminium halide, the relatively non-volatile aluminium material is less volatile than the aluminium halide, wherein the aluminium halide-reactive material is a halide of an element selected from either one of group I or group II of the periodic table of the elements.

232. The process as claimed in claim 228, wherein the separating a separation fraction from the intermediate reaction product includes:
separating at least an intermediate operative fraction from the intermediate reaction product, wherein the intermediate operative fraction includes an intermediate operative fraction target metal material fraction including a respective concentration of target metal, wherein the intermediate operative fraction target metal material fraction consists of the produced metal halide, such that the intermediate operative fraction target metal material fraction includes the target metal, wherein the target metal is provided in a respective concentration within the intermediate operative fraction target metal material fraction which defines the respective concentration of target metal in the intermediate operative fraction target metal material fraction; and
distilling an operative separation fraction from the intermediate operative fraction, wherein the separation fraction includes the operative separation fraction, and wherein the operative separation fraction includes an operative separation fraction target metal material fraction including a respective concentration of target metal, wherein the operative separation fraction target metal material fraction consists of the recovered metal halide, such that the operative separation fraction target metal material fraction includes the target metal, wherein the target metal is provided in a respective concentration within the operative separation fraction target metal material fraction which defines the respective concentration of target metal in the operative separation fraction target metal material fraction; and
wherein the respective concentration of target metal in the operative separation fraction target metal material fraction of the operative separation fraction is greater than the respective concentration of target metal in the intermediate operative fraction target metal material fraction of the intermediate operative fraction.
